(19) United States
(12) Patent Application Publication
(10) Pub. No.: US 2026/0072803 A1
(43) Pub. Date: Mar. 12, 2026

(54) PERFORMANCE EVALUATION OF SOFTWARE USED FOR CELLULAR NETWORKS

(71) Applicant: DISH Wireless L.L.C., Englewood, CO (US)

(72) Inventor: Mian Rizwan Ishaq, Littleton, CO (US)

(21) Appl. No.: 18/830,455

(22) Filed: Sep. 10, 2024

(51) Int. Cl. G06F 11/34; G06F 11/30; G06F 11/32

(52) U.S. Cl. CPC G06F 11/3409; G06F 11/302; G06F 11/321

(57) ABSTRACT

A method includes receiving, from one or more first user devices, first data indicative of a performance of a first version of a software package installed on wireless equipment of a cellular network. The method also includes receiving, from one or more second user devices, second data indicative of a performance of a second version of the software package installed on the wireless equipment of the cellular network. The first data and second data are collected as the one or more first user devices and one or more second user devices, respectively, attempt to connect to the cellular network while traversing routes within a geographic region containing the wireless equipment. The method also includes presenting, on a display of a computing device, a user interface comprising one or more data visualizations of the first data and the second data.

### TECHNICAL FIELD

The description generally relates to techniques for evaluating the performance of software used for cellular networks (e.g., 5G radio access networks, 4G radio access networks, 3G radio access networks, etc.).

### BACKGROUND

Cellular networks (e.g., cellular radio access networks, cellular core networks, etc.) are telecommunications networks that include a number of distributed devices that send, receive, and/or process wireless signals across the network to provide coverage to a geographical area. Implementations of cellular networks typically involve the use of software that performs various functions such as controlling parameters of the distributed devices (e.g., small cells) in the cellular network; managing interference on the cellular network; broadcasting, establishing, and releasing connections between devices (e.g., to perform signal handovers); handling data transmissions; initiating and managing voice calls and video calls; etc. The performance of such software can affect characteristics such as signal strength, network throughput, breadth of coverage, etc. of the cellular network.

### SUMMARY

This document describes techniques for evaluating the performance of software used for cellular networks (sometimes referred to as “benchmarking” the software). In some cases, the software used for cellular networks can be implemented on the wireless equipment of the cellular network (e.g., in small cells or cell towers of the cellular network), on the user devices that connect to the cellular network, or both. Providers of wireless cellular networks may receive such software from external parties (e.g., from the providers of user devices) or may internally develop such software. When new software is received or developed, it can be important to evaluate the performance of the new software to ensure that that there are no unexpected issues, to ensure that desired features from previous software are still provided, to ensure that one or more performance characteristics (e.g., signal strength, network throughput, coverage distance, etc.) are within a desired range (e.g., above a certain threshold or better than the performance characteristics of previous software), etc. It can also be useful to evaluate the performance of existing software, for example, to ensure that performance characteristics have not decreased over time.

One technique for evaluating the performance of software used for cellular networks is to selectively implement the software in particular sites in a region (e.g., one or more cellular towers in a city or a town). Then, one or more user devices configured to access the cellular network can be transported around the region (e.g., by employees of the relevant cellular network provider) so that the one or more user devices connect to (or attempt to connect to) various cell towers of the cellular network. As the one or more user devices connect to (or attempt to) the cell towers of the cellular network, data can be collected such as location data of the one or more user devices, a distance between each of the user devices and the cell tower they are connected to, a signal strength of the connection (e.g., a reference signal received power [RSRP], received signal strength indicator [RSSI], etc.), a metric indicative of throughput (e.g., data speeds), a metric indicative of retainability (e.g., number or percentage of dropped calls), a metric indicative of signal quality (e.g., signal to interference and noise ratio [SINR]), and/or other performance metrics. In some cases, the collected data can be aggregated or linked with other data such as a type of the one or more user devices (e.g., a manufacture or model), a technology mode of the wireless equipment connected to (e.g., Long-Term Evolution [LTE], Long-Term Evolution-5G New Radio [LTE-5GNR]), a logic implemented by the cellular network (e.g., a particular version of a software package, or a software package implemented with particular parameters), etc. The aggregated or linked data can then be used to benchmark the software implemented in the region. In some cases, this software benchmarking technique can be performed repeatedly (e.g., once a month, once every two months, once every three months, whenever new software is received or developed, whenever a new type of user device is released, etc.).

In one aspect, a method is featured. The method includes receiving, from one or more first user devices, first data indicative of a performance of a first version of a software package installed on wireless equipment of a cellular network. The first data is collected as the one or more first user devices attempt to connect to the cellular network while traversing a first route within a geographic region containing the wireless equipment. The method also includes receiving, from one or more second user devices, second data indicative of a performance of a second version of the software package installed on the wireless equipment of the cellular network. The second data is collected as the one or more second user devices attempt to connect to the cellular network while traversing a second route within the geographic region. The method also includes presenting, on a display of a computing device, a user interface including one or more data visualizations of the first data and the second data. The user interface further includes one or more user-selectable options, each user-selectable option corresponding to a particular version of the software package. The one or more data visualizations are configured to dynamically update based on a user selection of the one or more user-selectable options.

Implementations can include the examples described below and herein elsewhere. In some implementations, at least some of the one or more first user devices are the same devices as at least some of the one or more second user devices. In some implementations, the first route within the geographic region is substantially similar to the second route within the geographic region. In some implementations, the first version of the software package and the second version of the software package control parameters of the wireless equipment of the cellular network; manage interference on the cellular network; broadcast, establish, and release connections to the cellular network; handle data transmissions within the cellular network; and/or initiate and manage calls. In some implementations, the first data and the second data each include information representative of a signal strength of a connection to the cellular network, a throughput of the cellular network, a coverage distance of the cellular network, and/or a technology mode of the wireless equipment of the cellular network. In some implementations, the method can include comparing the performance of the first version of the software package with the performance of the second version of the software package based on the one or more data visualizations. In some implementations, the method can include determining, based on the one or more data visualizations, whether a performance characteristic of the first version of the software package and/or the second version of the software package satisfy a pre-defined threshold level corresponding to the performance characteristic. In some implementations, the pre-defined threshold level corresponds to a level of the performance characteristic achieved by a pre-existing version of the software package. In some implementations, the method can include comparing the first data and the second data; in response to comparing the first data and the second data, selecting whether to implement the first version of the software package or the second version of the software package in additional wireless equipment of the cellular network outside of the geographic region; and implementing, in accordance with the selection, the first version of the software package or the second version of the software package in the additional wireless equipment of the cellular network outside of the geographic region. In some implementations, the method can also include comparing the first data and the second data; in response to comparing the first data and the second data, automatically identifying a performance characteristic of the first version of the software package and/or the second version of the software package that does not satisfy a pre-defined threshold level corresponding to the performance characteristic; and presenting, on the display of the computing device, a recommendation to modify a feature of the first version of the software package and/or a feature of the second version of the software package relating to the identified performance characteristic.

In another aspect, a computing system is featured. The computing system includes a display, a memory configured to store instructions, and one or more processors configured to execute the instructions to perform operations. The operations include receiving, from one or more first user devices, first data indicative of a performance of a first version of a software package installed on wireless equipment of a cellular network. The first data is collected as the one or more first user devices attempt to connect to the cellular network while traversing a first route within a geographic region containing the wireless equipment. The operations also include receiving, from one or more second user devices, second data indicative of a performance of a second version of the software package installed on the wireless equipment of the cellular network. The second data is collected as the one or more second user devices attempt to connect to the cellular network while traversing a second route within the geographic region. The operations also include presenting, on the display of the computing device, a user interface including one or more data visualizations of the first data and the second data. The user interface further includes one or more user-selectable options, each user-selectable option corresponding to a particular version of the software package. The one or more data visualizations are configured to dynamically update based on a user selection of the one or more user-selectable options.

Implementations can include the examples described below and herein elsewhere. In some implementations, at least some of the one or more first user devices are the same devices as at least some of the one or more second user devices. In some implementations, the first route within the geographic region is substantially similar to the second route within the geographic region. In some implementations, the first version of the software package and the second version of the software package control parameters of the wireless equipment of the cellular network; manage interference on the cellular network; broadcast, establish, and release connections to the cellular network; handle data transmissions within the cellular network; and/or initiate and manage calls. In some implementations, the first data and the second data each include information representative of a signal strength of a connection to the cellular network, a throughput of the cellular network, a coverage distance of the cellular network, and/or a technology mode of the wireless equipment of the cellular network. In some implementations, the operations can include comparing the performance of the first version of the software package with the performance of the second version of the software package based on the one or more data visualizations. In some implementations, the operations can include determining, based on the one or more data visualizations, whether a performance characteristic of the first version of the software package and/or the second version of the software package satisfy a pre-defined threshold level corresponding to the performance characteristic. In some implementations, the pre-defined threshold level corresponds to a level of the performance characteristic achieved by a pre-existing version of the software package. In some implementations, the operations can include comparing the first data and the second data; in response to comparing the first data and the second data, selecting whether to implement the first version of the software package or the second version of the software package in additional wireless equipment of the cellular network outside of the geographic region; and implementing, in accordance with the selection, the first version of the software package or the second version of the software package in the additional wireless equipment of the cellular network outside of the geographic region. In some implementations, the operations can also include comparing the first data and the second data; in response to comparing the first data and the second data, automatically identifying a performance characteristic of the first version of the software package and/or the second version of the software package that does not satisfy a pre-defined threshold level corresponding to the performance characteristic; and presenting, on the display of the computing device, a recommendation to modify a feature of the first version of the software package and/or a feature of the second version of the software package relating to the identified performance characteristic.

In another aspect, one or more non-transitory machine-readable storage media are featured. The one or more non-transitory machine-readable storage media store instructions that can be executed to perform operations. The operations include receiving, from one or more first user devices, first data indicative of a performance of a first version of a software package installed on wireless equipment of a cellular network. The first data is collected as the one or more first user devices attempt to connect to the cellular network while traversing a first route within a geographic region containing the wireless equipment. The operations also include receiving, from one or more second user devices, second data indicative of a performance of a second version of the software package installed on the wireless equipment of the cellular network. The second data is collected as the one or more second user devices attempt to connect to the cellular network while traversing a second route within the geographic region. The operations also include presenting, on the display of the computing device, a user interface including one or more data visualizations of the first data and the second data. The user interface further includes one or more user-selectable options, each user-selectable option corresponding to a particular version of the software package. The one or more data visualizations are configured to dynamically update based on a user selection of the one or more user-selectable options.

Implementations can include the examples described below and herein elsewhere. In some implementations, at least some of the one or more first user devices are the same devices as at least some of the one or more second user devices. In some implementations, the first route within the geographic region is substantially similar to the second route within the geographic region. In some implementations, the first version of the software package and the second version of the software package control parameters of the wireless equipment of the cellular network; manage interference on the cellular network; broadcast, establish, and release connections to the cellular network; handle data transmissions within the cellular network; and/or initiate and manage calls. In some implementations, the first data and the second data each include information representative of a signal strength of a connection to the cellular network, a throughput of the cellular network, a coverage distance of the cellular network, and/or a technology mode of the wireless equipment of the cellular network. In some implementations, the operations can include comparing the performance of the first version of the software package with the performance of the second version of the software package based on the one or more data visualizations. In some implementations, the operations can include determining, based on the one or more data visualizations, whether a performance characteristic of the first version of the software package and/or the second version of the software package satisfy a pre-defined threshold level corresponding to the performance characteristic. In some implementations, the pre-defined threshold level corresponds to a level of the performance characteristic achieved by a pre-existing version of the software package. In some implementations, the operations can include comparing the first data and the second data; in response to comparing the first data and the second data, selecting whether to implement the first version of the software package or the second version of the software package in additional wireless equipment of the cellular network outside of the geographic region; and implementing, in accordance with the selection, the first version of the software package or the second version of the software package in the additional wireless equipment of the cellular network outside of the geographic region. In some implementations, the operations can also include comparing the first data and the second data; in response to comparing the first data and the second data, automatically identifying a performance characteristic of the first version of the software package and/or the second version of the software package that does not satisfy a pre-defined threshold level corresponding to the performance characteristic; and presenting, on the display of the computing device, a recommendation to modify a feature of the first version of the software package and/or a feature of the second version of the software package relating to the identified performance characteristic.

Various implementations of the technology described herein may provide one or more of the following advantages. The techniques described herein can reduce disruptions to network performance during the software benchmarking process by implementing software only in selected sites and time periods for evaluation purposes. Furthermore, the techniques described herein can enable direct performance comparisons of different software implementations in real-world settings through the collection of empirical user session data, which can be used to optimize network performance. The techniques described herein can also enable controlled comparisons of the software performance for multiple different device types, for example, by simultaneously transporting multiple user devices along the same route during the data collection process. In some implementations, the software performance data collected can be stored in a memory (e.g., a database) for additional comparisons. In some implementations, the technology described herein can also have the advantage of informing or automatically making decisions about which versions of a software to implement on the cellular network (or which parameter values to use within the software). In some implementations, the technology described herein can also have the advantage of helping a software provider to identify, or automatically identifying, performance characteristics/features that need to be improved or fixed.

Other features and advantages of the description will become apparent from the following description, and from the claims. Unless otherwise defined, the technical and scientific terms used herein have the same meaning as commonly understood by one of ordinary skill in the art to which this invention belongs.

### BRIEF DESCRIPTION OF DRAWINGS

FIG. 1 is a flowchart showing a software benchmarking process for evaluating performance of software used for cellular networks.

FIGS. 2A-2C show an example route traversed by a user device during a software benchmarking process, and data collected during the software benchmarking process.

FIG. 3 shows example summary data collected for six different software logics during a software benchmarking process.

FIGS. 4-20 show user interfaces including visualizations of data collected for six different software logics during a software benchmarking process.

FIG. 21 is a diagram illustrating an example of a computing environment.

### DETAILED DESCRIPTION

The operation of cellular networks (e.g., cellular radio access networks, cellular core networks, etc.) involves the use of software to perform various functions. For example, the software can be implemented as software packages on devices of the cellular network (e.g., small cells or other wireless equipment of the cellular network) to perform functions including controlling parameters of the devices of the cellular network; managing interference on the cellular network; broadcasting, establishing, and releasing connections between devices (e.g., to perform signal handovers); handling data transmissions; initiating and managing voice calls and video calls; etc. Software can also be implemented on user devices (e.g., “user equipment” (UE)) that connect to and otherwise interface with the cellular network.

The specific implementations of software used to operate a cellular network can have substantial implications for the performance of the cellular network, and accordingly, metrics of cellular network performance that are attributable (at least in part) to the software are sometimes referred to herein as “performance characteristics” of the software. These performance characteristics can include metrics indicative of signal strength (e.g., a reference signal received power [RSRP], received signal strength indicator [RSSI], etc.), metrics indicative of throughput (e.g., data speeds), metrics indicative of retainability (e.g., number or percentage of dropped calls), metrics indicative of signal quality (e.g., signal to interference and noise ratio [SINR]), etc. In some implementations, these performance characteristics can be measured or calculated based on data collected from user sessions of UEs that connect to (or attempt to connect to) the cellular network. Other data that can be collected from these user sessions to assess performance characteristics of the software implemented on the cellular network include location data of the UEs, a distance between each of the UEs and the cell tower they are connected to, a type of the one or more UEs (e.g., a manufacture or model), a technology mode of the wireless equipment connected to (e.g., Long-Term Evolution [LTE], Long-Term Evolution-5G New Radio [LTE-5GNR]), a logic implemented by the cellular network (e.g., a particular version of a software package, or a software package implemented with particular parameters), etc.

Since the software used to operate a cellular network can have substantial effects on the cellular network's performance, it can be beneficial for a provider of a cellular network to evaluate or “benchmark” the performance characteristics of the software it implements (or plans to implement) on the cellular network. For example, benchmarking the software can enable the provider of the cellular network to reduce the risk that, when it rolls out new or updated software on the cellular network, there will be unexpected errors or decreased network performance. Benchmarking can also allow the software provider to monitor the performance of software already being implemented on the network, for example, to identify areas for performance improvement. In some implementations, software benchmarking can also enable the automated selection of software to be implemented on the cellular network, the identification of software features that can/should be improved/fixed, and even the generation of recommendations for fixing/improving software issues (e.g., for software developers who may or may not be distinct entities from the cellular network provider).

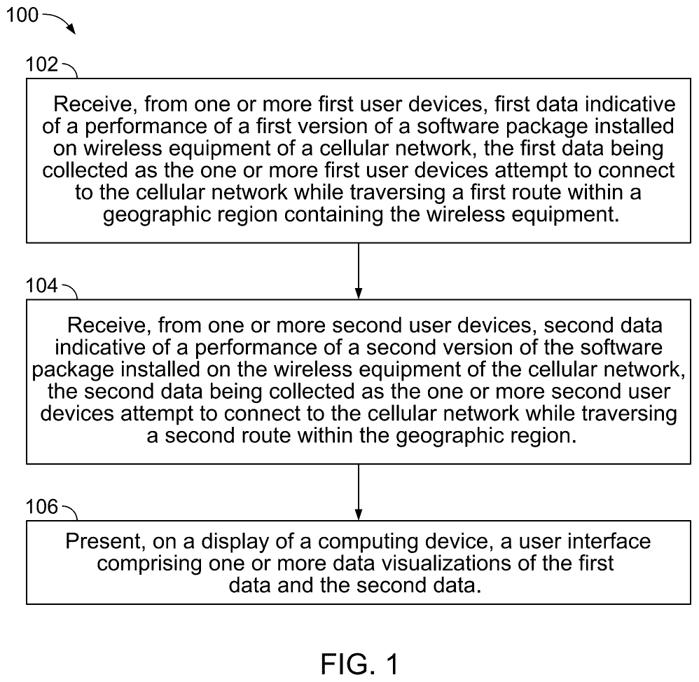

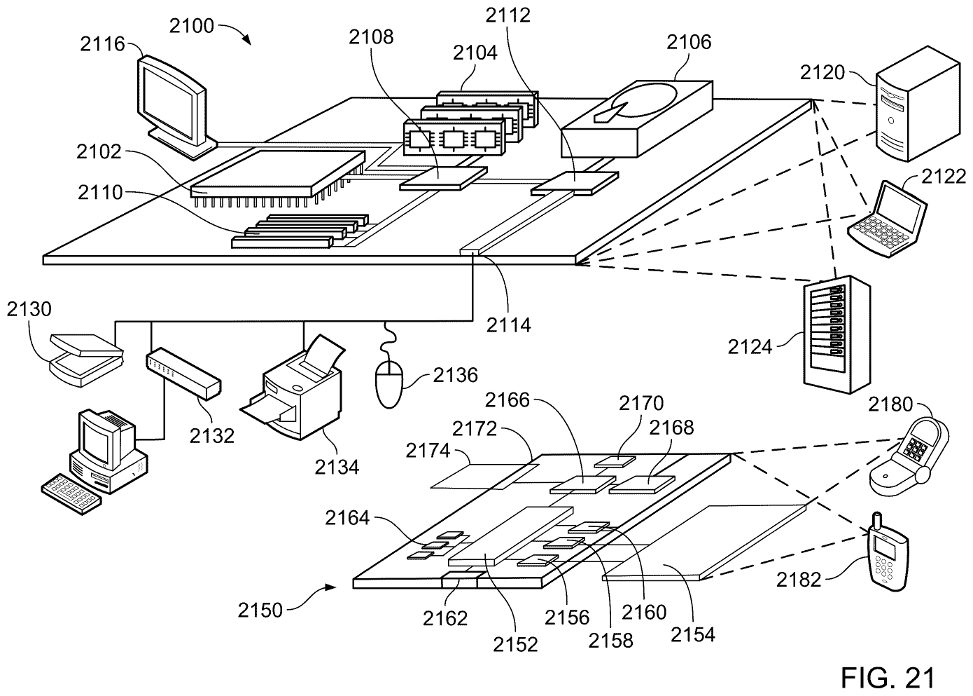

This document describes technologies for benchmarking software used for cellular networks. An example software benchmarking process 100 is shown in FIG. 1 and will be used to illustrate and describe various embodiments provided herein. In some implementations, operations of the process 100 can be executed by one or more computing devices or mobile computing devices such as those described below in relation to FIG. 21.

Operations of the process 100 include receiving, from one or more first user devices, first data indicative of a performance of a first version of a software package installed on wireless equipment of a cellular network, the first data being collected as the one or more first user devices attempt to connect to the cellular network while traversing a first route within a geographic region containing the wireless equipment (operation 102). For example, to benchmark a version of a software package, a provider of a cellular network might not wish to simultaneously roll out the software package across the entire cellular network. Instead, the cellular network provider may choose to implement the software on only the wireless equipment (e.g., small cells or node devices) within a particular geographic region (e.g., a particular county, a particular city, etc.). This can help prevent widespread and unnecessary reductions in network performance that may be caused by more broadly implementing a software package that has not yet been evaluated.

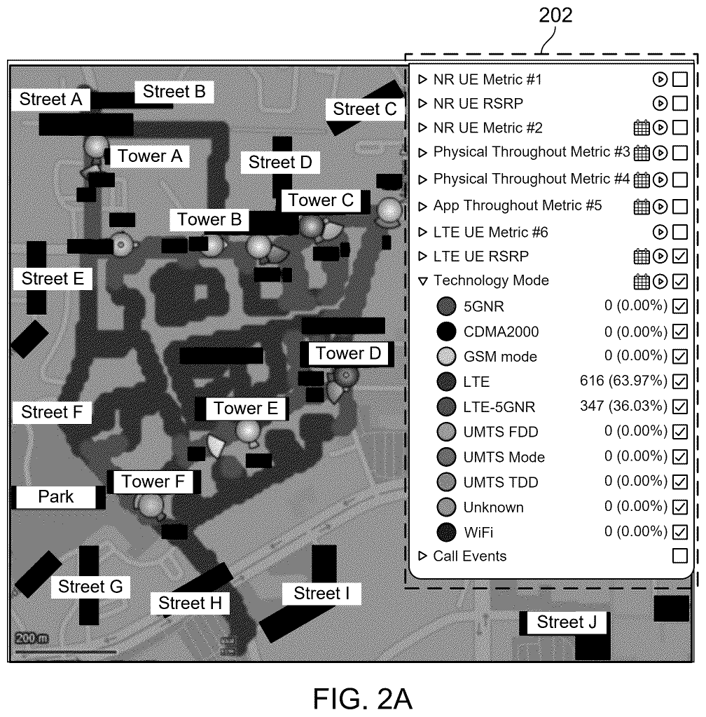

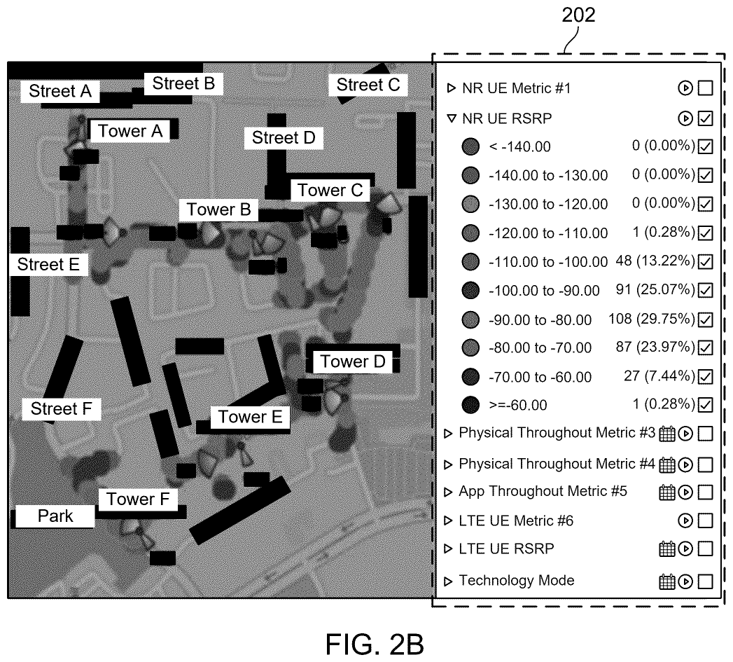

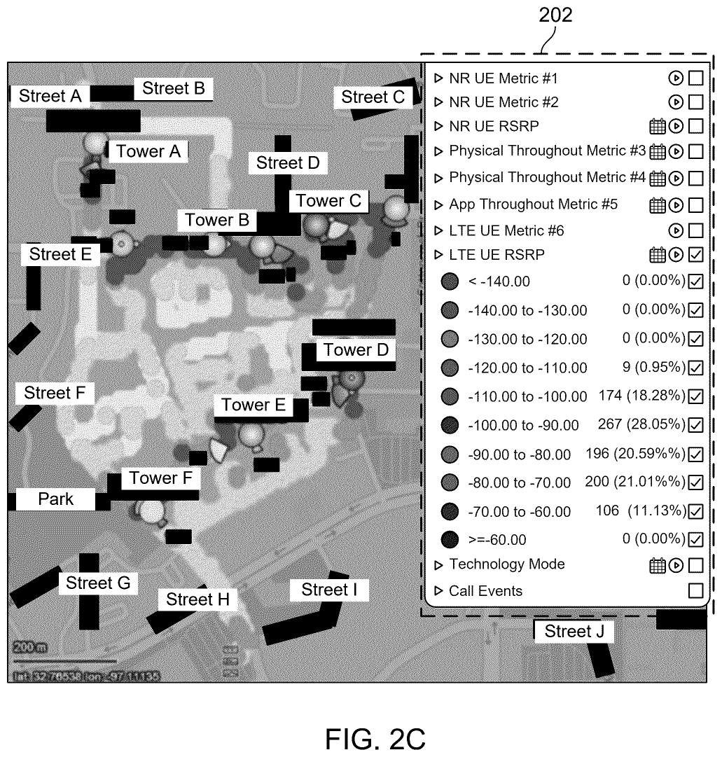

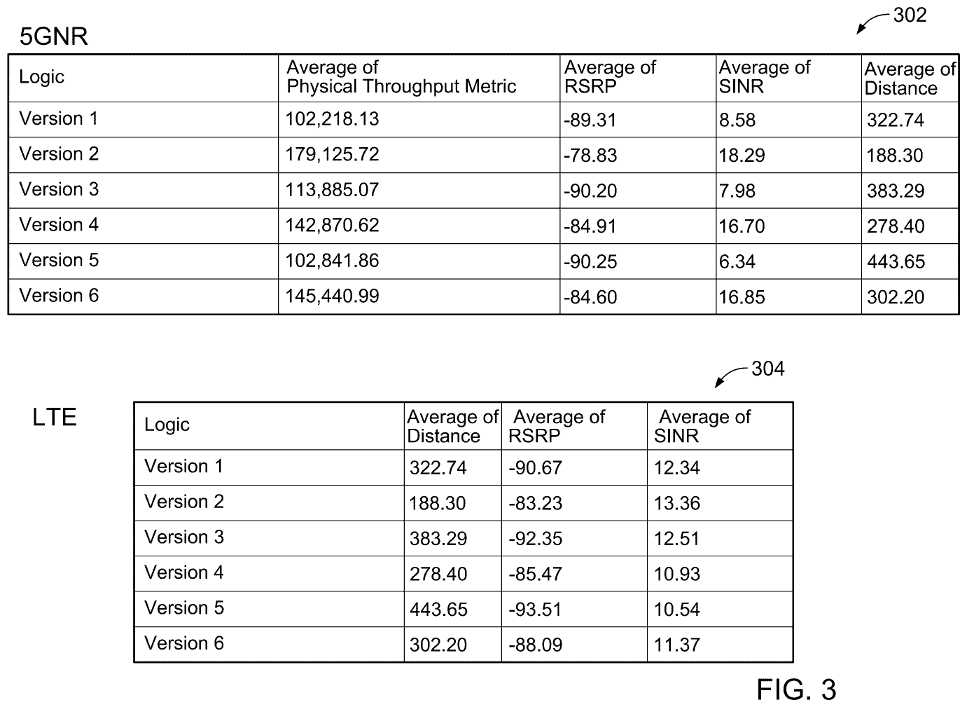

Upon implementing the version of the software package that is to be benchmarked, one or more user devices can be transported (e.g., by the cellular network provider or another entity) through the geographic region while attempting to connect to the cellular network. In some cases, it can be useful to transport multiple user devices simultaneously such that directly comparable data can be obtained, for example, from multiple types of devices, multiple instances of a single device type, etc. Data collected during this process can include various kinds of information including data indicative of a performance of the version of the software package being evaluated. For example, the collected data can include metrics indicative of signal strength (e.g., a reference signal received power [RSRP], received signal strength indicator [RSSI], etc.), metrics indicative of throughput (e.g., data speeds), metrics indicative of retainability (e.g., number or percentage of dropped calls), metrics indicative of signal quality (e.g., signal to interference and noise ratio [SINR]), etc. The data collected can also include location data of the UEs, a distance between each of the UEs and the cell tower they are connected to, a type of the one or more UEs (e.g., a manufacture or model), a technology mode of the wireless equipment connected to (e.g., Long-Term Evolution [LTE], Long-Term Evolution-5G New Radio [LTE-5GNR]), a logic implemented by the cellular network (e.g., a particular version of a software package, or a software package implemented with particular parameters). Example routes of user devices through a geographic region (including a subset of data collected along the routes) are shown in FIGS. 2A-2C, which are described in further detail below. Additional examples of the kinds of data that can be collected are shown in FIG. 3, which is also described in further detail below.

Operations of the process 100 also include receiving, from one or more second user devices, second data indicative of a performance of a second version of the software package installed on the wireless equipment of the cellular network, the second data being collected as the one or more second user devices attempt to connect to the cellular network while traversing a second route within the geographic region (operation 104).

The operation 104 can be performed similarly to the operation 102 described above, except with a different version of a software package implemented on the wireless equipment of the cellular network. By evaluating the performance characteristics of different versions of the software package (or in some cases, the same version of the software package with different parameter values), a cellular network provider is able to directly compare and assess the relative performance of each software package. In some cases, the user devices used for operation 104 can be the same user devices used for operation 102 (e.g., to enable a direct comparison), but in some cases, the user devices used for operations 102 and 104 can also be different. Likewise, in some cases, the route traversed by the user devices in operation 102 can be identical (or substantially similar) to the route traversed by the user devices in operation 104; in other cases, however, the routes may be different.

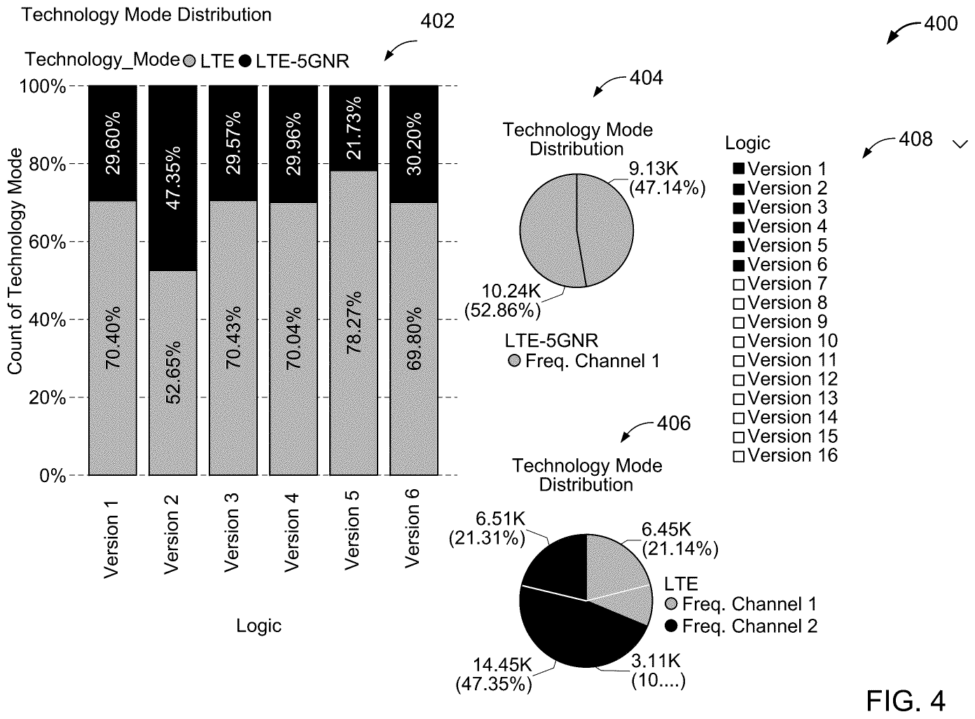

Operations of the process 100 also include presenting, on a display of a computing device, a user interface comprising one or more data visualizations of the first data and the second data (operations 106). Example user interfaces and data visualizations are shown and described below in relation to FIGS. 4-20. However, at a high level, these data visualizations enable direct comparisons of performance characteristics (e.g., signal strength, throughput, coverage distance, signal quality, etc.) for different software packages. As shown and described through the examples below, the user interface can include one or more user-selectable options that each correspond to a particular version of a software package. When a user selects one or more of these user-selectable options, the one or more data visualizations can be configured to dynamically update, enabling rapid and direct comparisons between various software package versions of interest.

In some implementations, pre-defined thresholds levels can be established for one or more performance characteristics of the software packages that are evaluated. For example, a cellular network provider may require that any software package it implements across its cellular network enable accessibility rates to the network of over 95%, over 99%, over 99.9%, over 99.99%, etc. As another example, a cellular network provider may require that any software package it implements across its cellular network retain connections (e.g., without dropped calls) of over 95%, over 99%, over 99.9%, over 99.99%, etc. Where pre-defined threshold level(s) for performance characteristics have been established, the process 100 can further include automating a decision whether or not to implement a benchmarked software package based on whether or not all required threshold levels have been exceeded. In some implementations, the decision to implement a benchmarked software package on the cellular network can result in implementing the benchmarked software on additional wireless equipment of the cellular network outside of the geographic region in which benchmarking was performed (e.g., to more broadly roll out software that is determined to have desirable performance characteristics).

In some implementations, operations of the process 100 can also include automatically identifying a performance characteristic of the first version of the software package and/or the second version of the software package that does not satisfy a pre-defined threshold level corresponding to the performance characteristic. In such implementations, operations of the process 100 can further include presenting, on the display of the computing device, a recommendation to modify a feature of the first version of the software package and/or a feature of the second version of the software package relating to the identified performance characteristic. This automated detection of potential issues and generation of modification recommendations can be highly beneficial for software developers to improve upon and/or fix software packages that are developed for implementation on cellular networks.

FIGS. 2A-2C illustrate an example route traversed by a user device during a software benchmarking process (e.g., the process 100) and data collected during the software benchmarking process. For example, FIG. 2A shows a route traversed by a user device while a particular version of a software package was implemented on wireless equipment in a geographic region. Along the route, data was collected about the technology mode of the wireless equipment connected to, and as shown in FIG. 2A, the user device was connected to LTE wireless equipment for 63.97% of the route and to LTE-5GNR wireless equipment for 36.03% of the route. FIG. 2B shows an alternative data visualization that illustrates the signal strength (more specifically, reference signal received power [RSRP]) of the connection for the portions of the route where the user device was connected to LTE-5GNR wireless equipment. FIG. 2C shows yet another alternative data visualization that illustrates the RSRP of the connection for the entire route (e.g., portions of the route where the user device was connected to LTE-5GNR wireless equipment and portions of the route where the user device was connected to LTE wireless equipment). The visualizations shown in FIGS. 2A-2C are examples of the data visualizations that can be presented on the display of a computing device (operation 106 of the process 100). As shown in FIGS. 2A-2C, control over the visualizations is provided by a menu 202 on the user interface that includes multiple user-selectable options. These user-selectable options enable a user to rapidly and dynamically update the visualizations to analyze various performance characteristics of the software being evaluated.

FIG. 3 shows an example of summary data collected for six different software versions (or “logics”) using a software benchmarking process such as the process 100. As shown in FIG. 3, data can be collected and then disaggregated based on the technology mode of the wireless equipment that one or more user devices connect to during the process 100 (e.g., 5GNR shown in data table 302 and LTE shown in data table 304). For each of these logics and technology modes, summary statistics (e.g., averages) can be calculated and displayed for data collected regarding the throughput (e.g., data speeds) of the connections, the signal strength of the connections (e.g., RSRP), the signal quality (e.g., SINR), and the distance between the user devices and the wireless equipment they connected to (referred to sometimes herein as “connection distance”).

FIGS. 4-21 show examples of user interfaces that include various visualizations that can be presented on a display of a computing device in accordance with operation 106 of the process 100 (described in relation to FIG. 1). FIG. 4 shows a user interface 400 that displays information about the technology modes of the wireless equipment that the one or more user devices connect to during data collection (e.g., operations 102 and 104 of the process 100). Visualization 402 of the user interface 400 shows a percentage breakdown, for six different logics, of whether the one or more user devices were connected to LTE wireless equipment or LTE-5GNR wireless equipment. Visualizations 404 and 406 of the user interface 400 show a percentage breakdown of the specific frequency channels connected to by the one or more user devices, further broken out by LTE-5GNR and LTE connections, respectively. The user interface 400 further includes a menu 408 that includes multiple user-selectable options corresponding to different software logics. These user-selectable options enable a user to rapidly and dynamically update the visualizations to analyze similar performance characteristics for different software logics of interest.

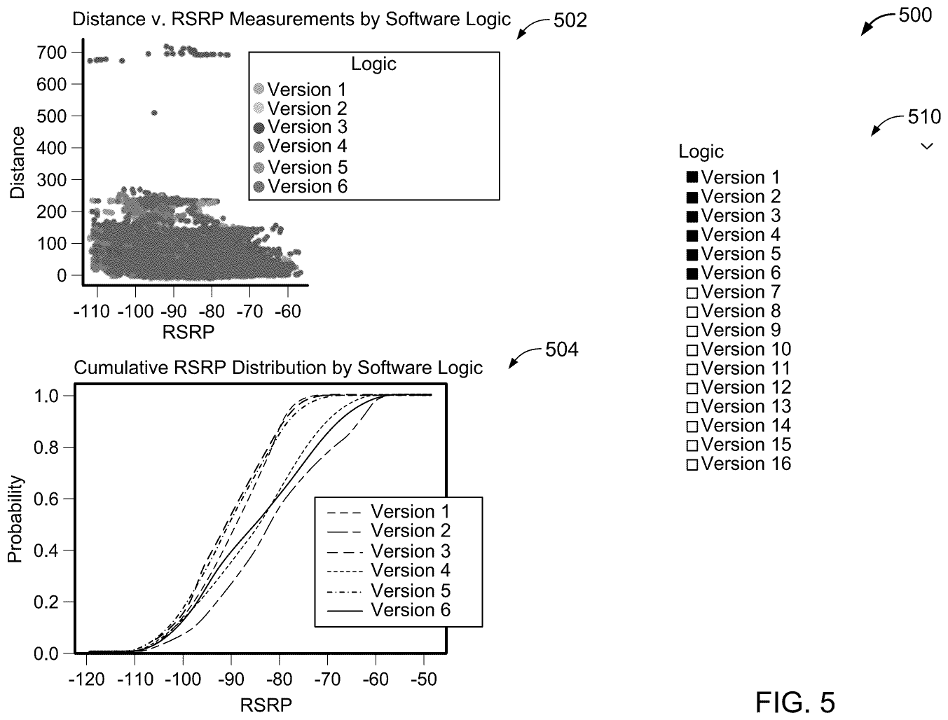

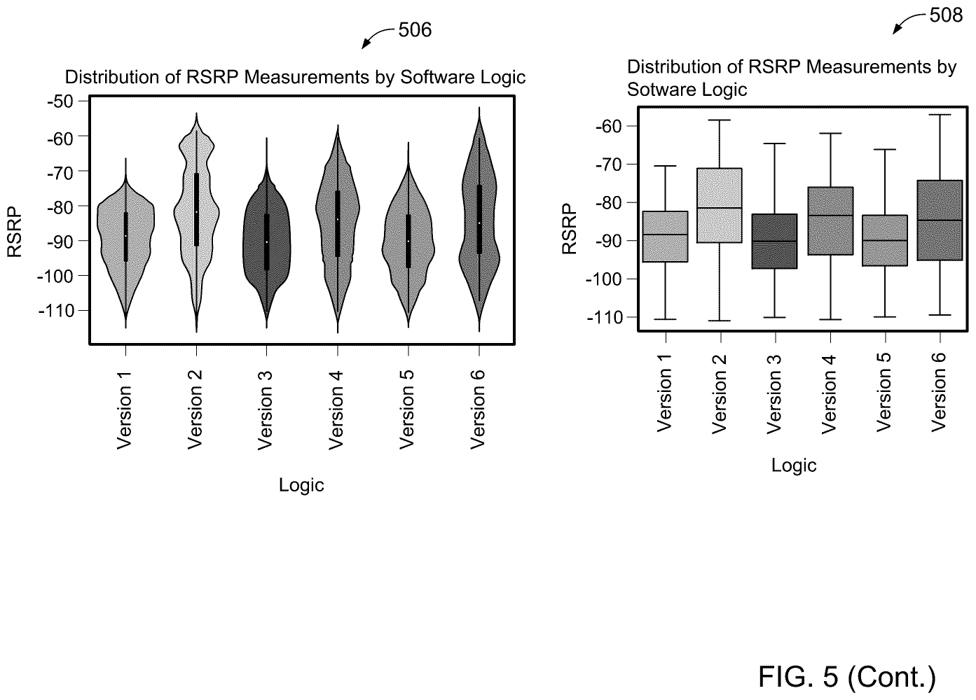

FIG. 5 shows a user interface 500 that displays information about the signal strength of the user device connections during data collection (e.g., operations 102 and 104 of the process 100). Visualization 502 of the user interface 500 shows, for six different software logics, a scatterplot of RSRP and connection distance. Visualization 504 of the user interface 500 shows a cumulative probability distribution of RSRPs for the same six software logics. Visualizations 506 and 508 of the user interface 500 show a violin plot and a box-and-whisker plot, respectively, of the RSRPs for the same six software logics. The user interface 500 further includes a menu 510 that includes multiple user-selectable options corresponding to different software logics. These user-selectable options enable a user to rapidly and dynamically update the visualizations to analyze similar performance characteristics for different software logics of interest.

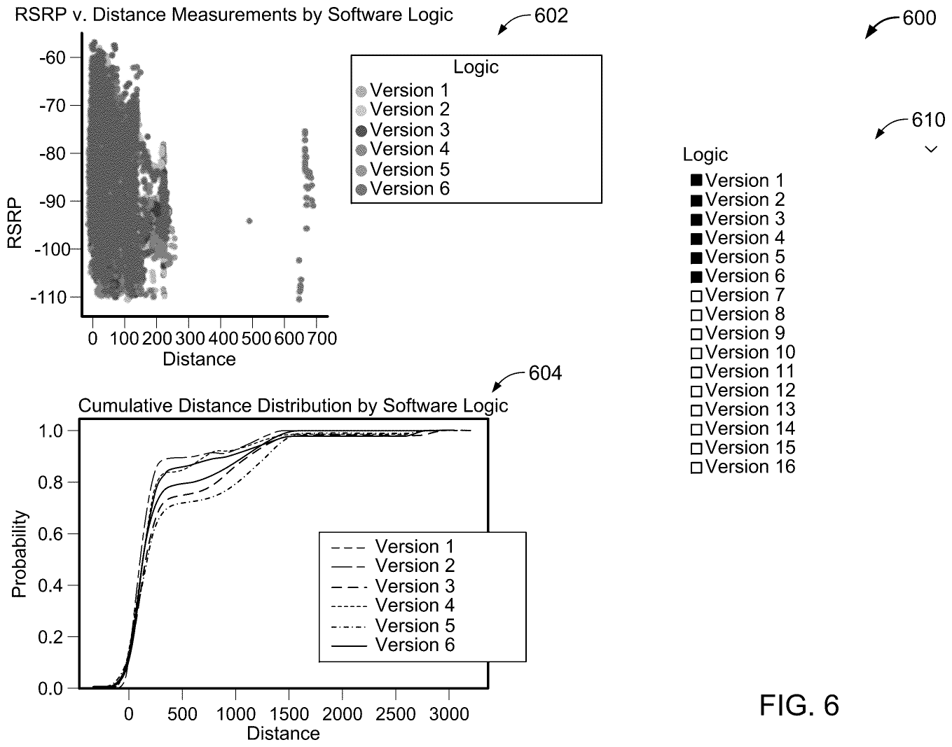

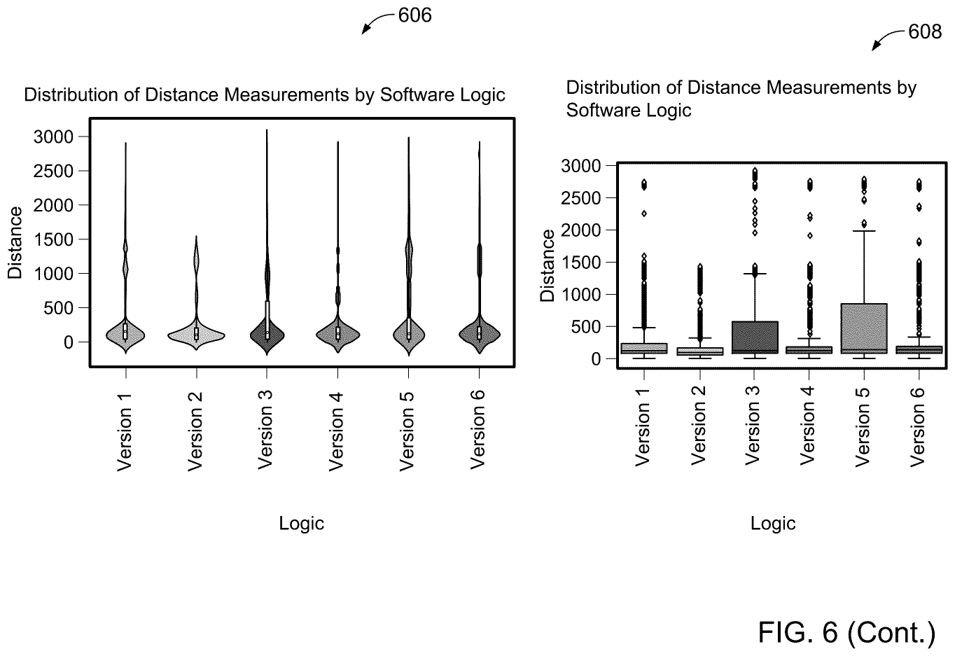

FIG. 6 shows a user interface 600 that displays information about the connection distance of the user device connections during data collection (e.g., operations 102 and 104 of the process 100). Visualization 602 of the user interface 600 shows, for six different software logics, a scatterplot of RSRP and connection distance. Visualization 604 of the user interface 600 shows a cumulative probability distribution of connection distances (in meters) for the same six software logics. Visualizations 606 and 608 of the user interface 600 show a violin plot and a box-and-whisker plot, respectively, of the connection distances for the same six software logics. The user interface 600 further includes a menu 610 that includes multiple user-selectable options corresponding to different software logics. These user-selectable options enable a user to rapidly and dynamically update the visualizations to analyze similar performance characteristics for different software logics of interest.

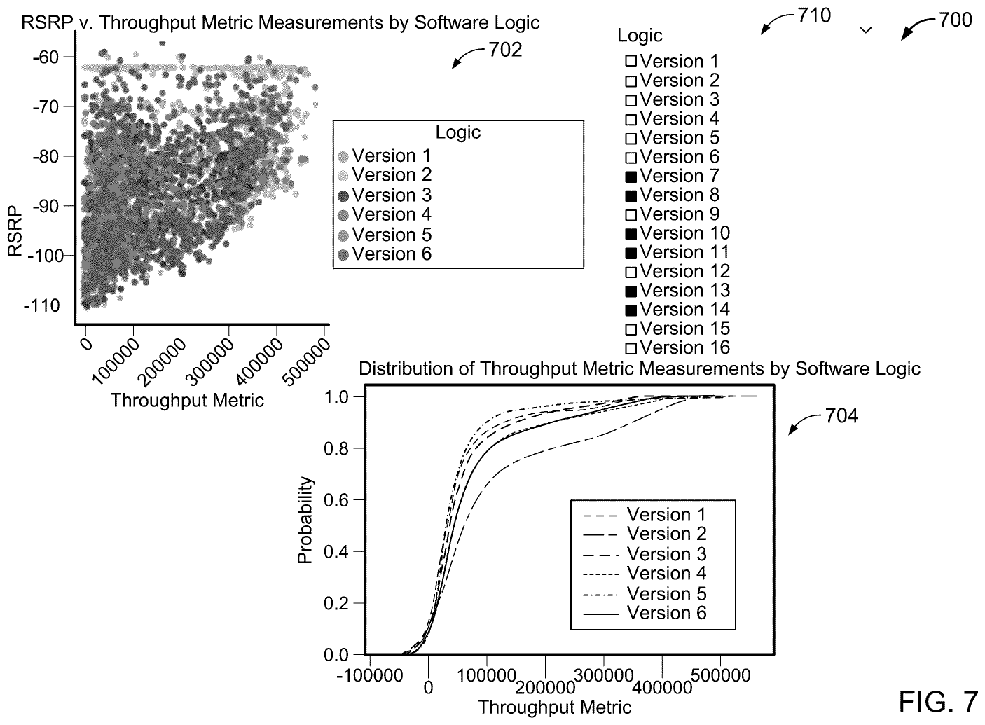

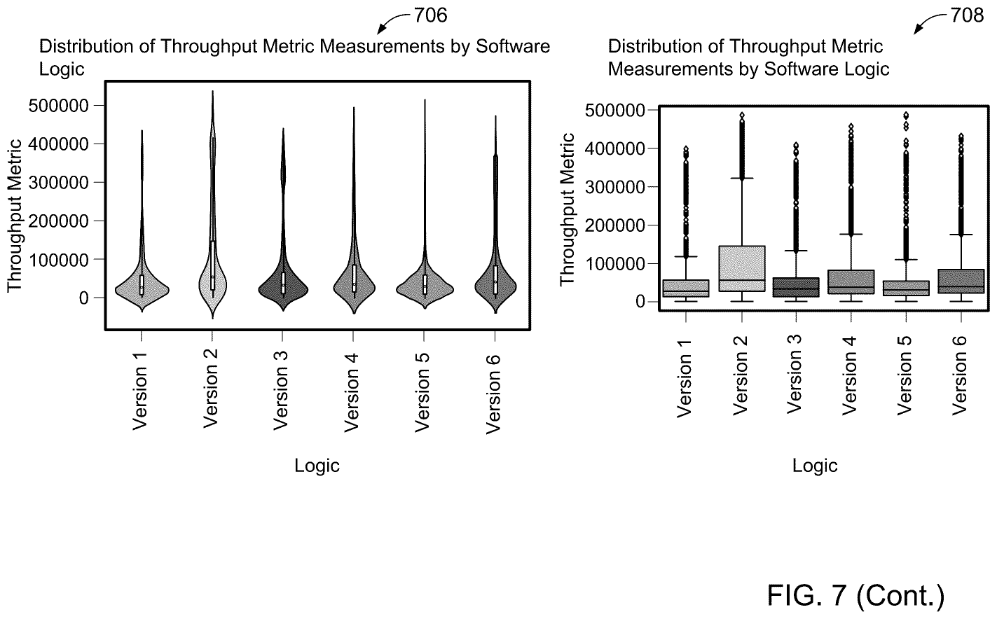

FIG. 7 shows a user interface 700 that displays information about the throughput of the user device connections during data collection (e.g., operations 102 and 104 of the process 100). Visualization 702 of the user interface 700 shows, for six different software logics, a scatterplot of RSRP and a throughput metric. Visualization 704 of the user interface 700 shows a cumulative probability distribution of the throughput metric for the same six software logics. Visualizations 706 and 708 of the user interface 700 show a violin plot and a box-and-whisker plot, respectively, of the throughput metric for the same six software logics. The user interface 700 further includes a menu 710 that includes multiple user-selectable options. These user-selectable options enable a user to rapidly and dynamically update the visualizations to analyze similar performance characteristics for different software logics of interest.

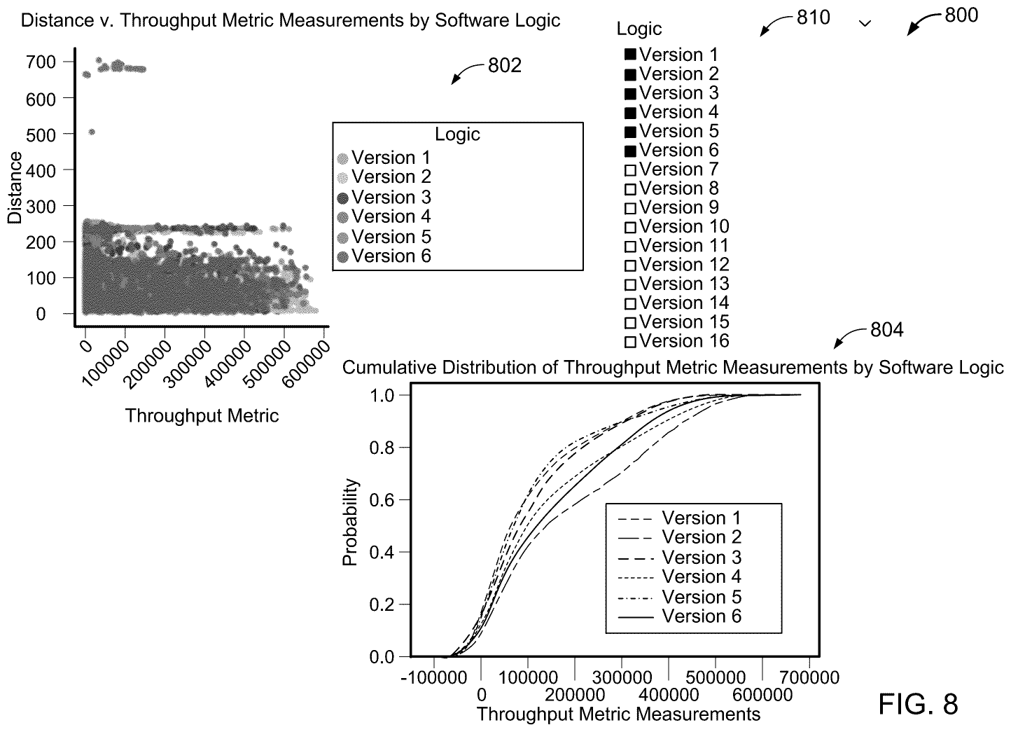

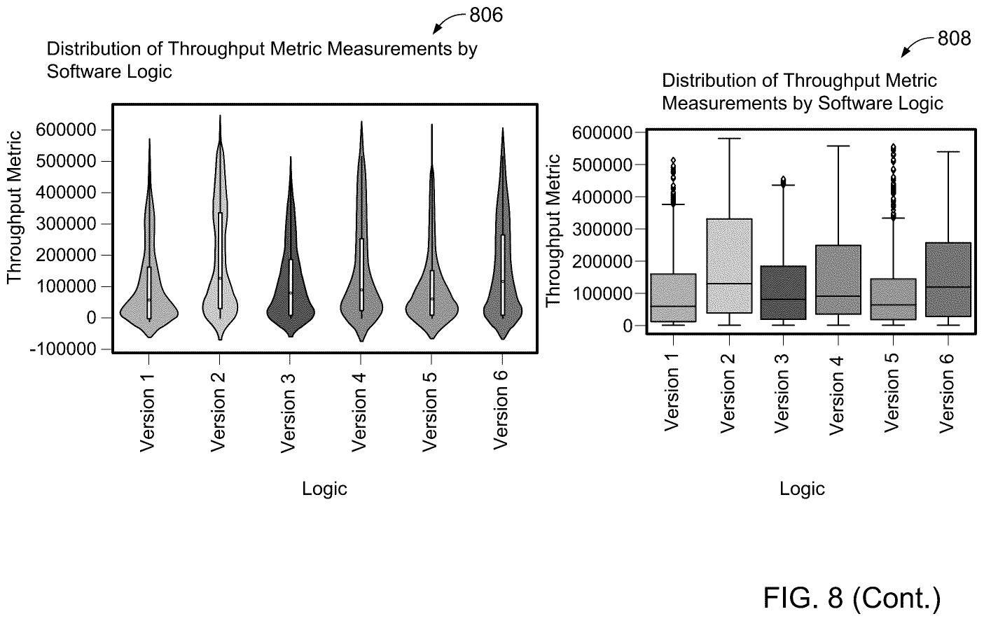

FIG. 8 shows a user interface 800 that displays information about the throughput of the user device connections during data collection (e.g., operations 102 and 104 of the process 100), using a different throughput metric than that used in FIG. 7. Visualization 802 of the user interface 800 shows, for six different software logics, a scatterplot of RSRP and the throughput metric. Visualization 804 of the user interface 800 shows a cumulative probability distribution of the throughput metric for the same six software logics. Visualizations 806 and 808 of the user interface 800 show a violin plot and a box-and-whisker plot, respectively, of the throughput metric for the same six software logics. The user interface 800 further includes a menu 810 that includes multiple user-selectable options corresponding to different software logics. These user-selectable options enable a user to rapidly and dynamically update the visualizations to analyze similar performance characteristics for different software logics of interest.

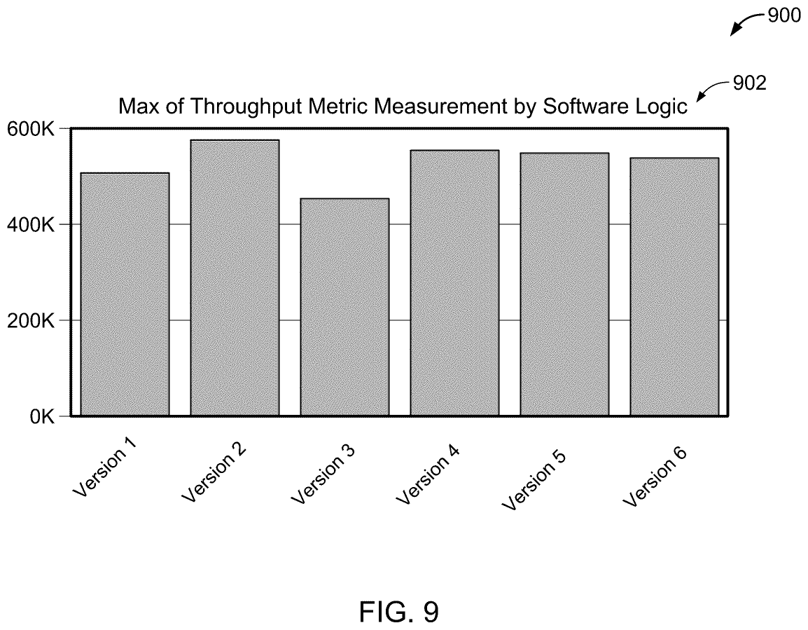

FIG. 9 shows a user interface 900 that displays information about the throughput of the user device connections during data collection (e.g., operations 102 and 104 of the process 100). Visualization 902 of the user interface 900 is a bar graph comparing the throughput metrics for six different software logics.

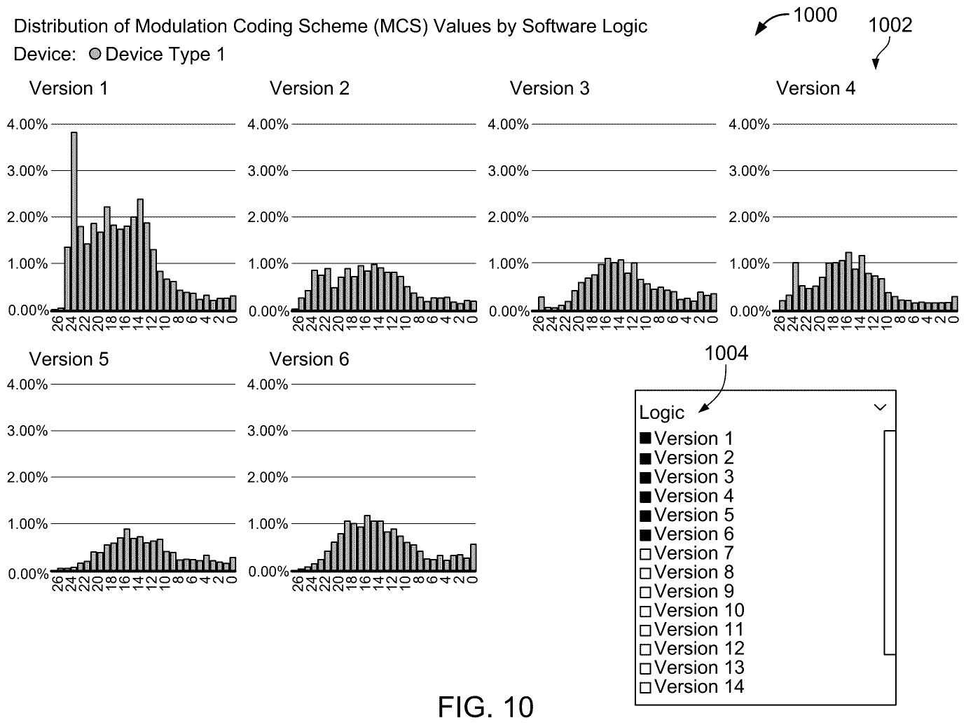

FIG. 10 shows a user interface 1000 that displays information about the data speed of the user device connections during data collection (e.g., operations 102 and 104 of the process 100), using an indicator called Modulation Coding Scheme (MCS). Visualization 1002 of the user interface 1000 shows, for each of six different software logics, a histogram showing the distribution of MCS values. The user interface 1000 further includes a menu 1004 that includes multiple user-selectable options corresponding to different software logics. These user-selectable options enable a user to rapidly and dynamically update the visualizations to analyze similar performance characteristics for different software logics of interest.

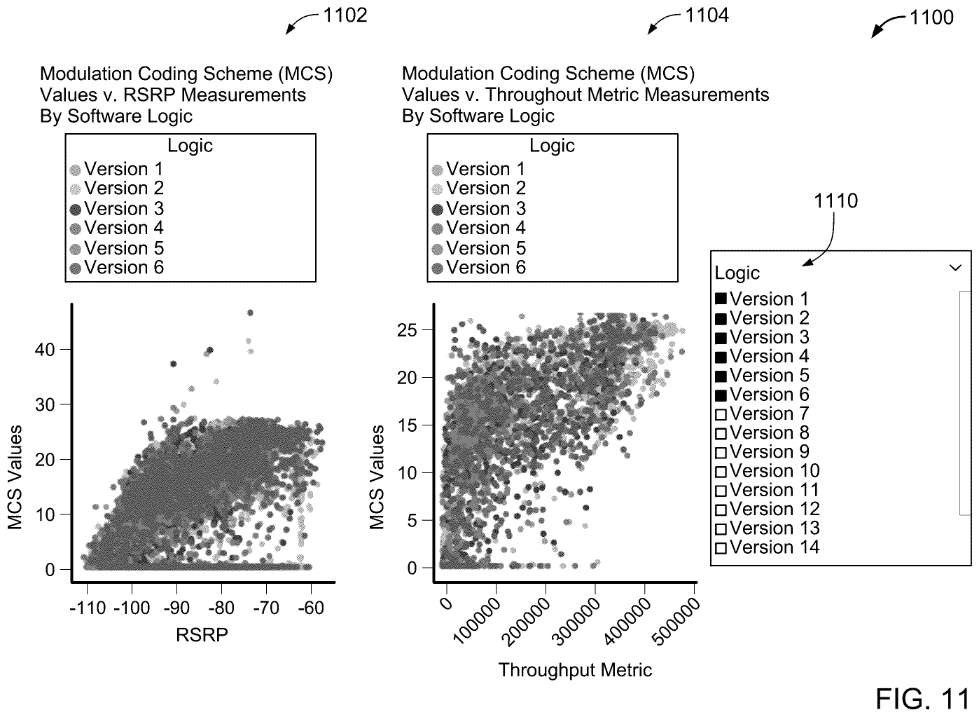

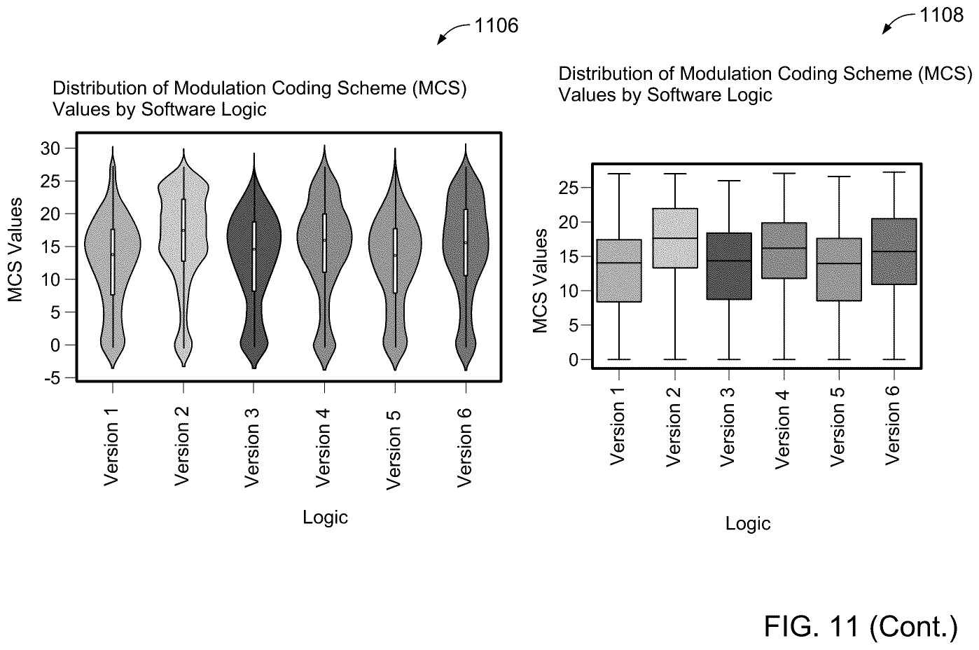

FIG. 11 shows a user interface 1100 that displays information about the data speed of the user device connections during data collection (e.g., operations 102 and 104 of the process 100), using the Modulation Coding Scheme (MCS) indicator. Visualization 1102 of the user interface 1100 shows, for six different software logics, a scatterplot of RSRP and MCS. Visualization 1104 of the user interface 1100 shows a scatterplot of MCS and a throughput metric for the same six software logics. Visualizations 1106 and 1108 of the user interface 1100 show a violin plot and a box-and-whisker plot, respectively, of the MCS values for the same six software logics. The user interface 1100 further includes a menu 1110 that includes multiple user-selectable options corresponding to different software logics. These user-selectable options enable a user to rapidly and dynamically update the visualizations to analyze similar performance characteristics for different software logics of interest.

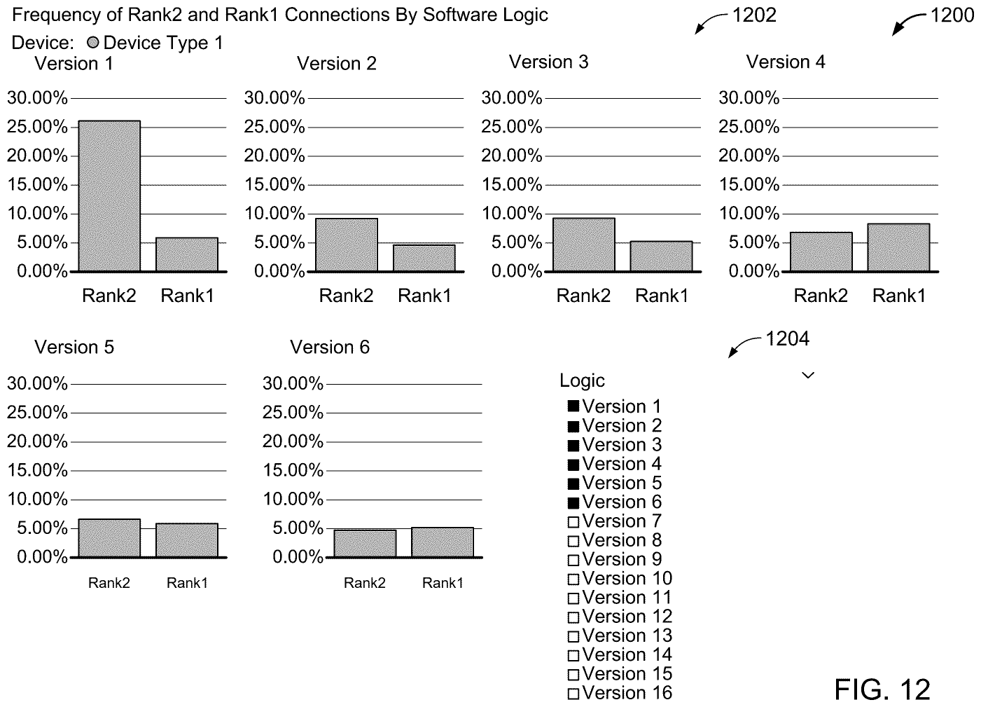

FIG. 12 shows a user interface 1200 that displays information about a number of antennas utilized for user device connections during data collection (e.g., operations 102 and 104 of the process 100). In FIG. 12, “Rank2” refers to the use of two receiving antenna at the user device while “Rank1” refers to the use of one receiving antenna at the user device. In general, multi-antenna connections result in better signal quality and throughput, so a larger proportion of Rank2 connections can be indicative of better software performance. Visualization 1202 of the user interface 1200 shows, for each of six different software logics, a bar graph comparing the relative number of Rank2 connections compared to Rank1 connections. The user interface 1200 further includes a menu 1204 that includes multiple user-selectable options corresponding to different software logics. These user-selectable options enable a user to rapidly and dynamically update the visualizations to analyze similar performance characteristics for different software logics of interest.

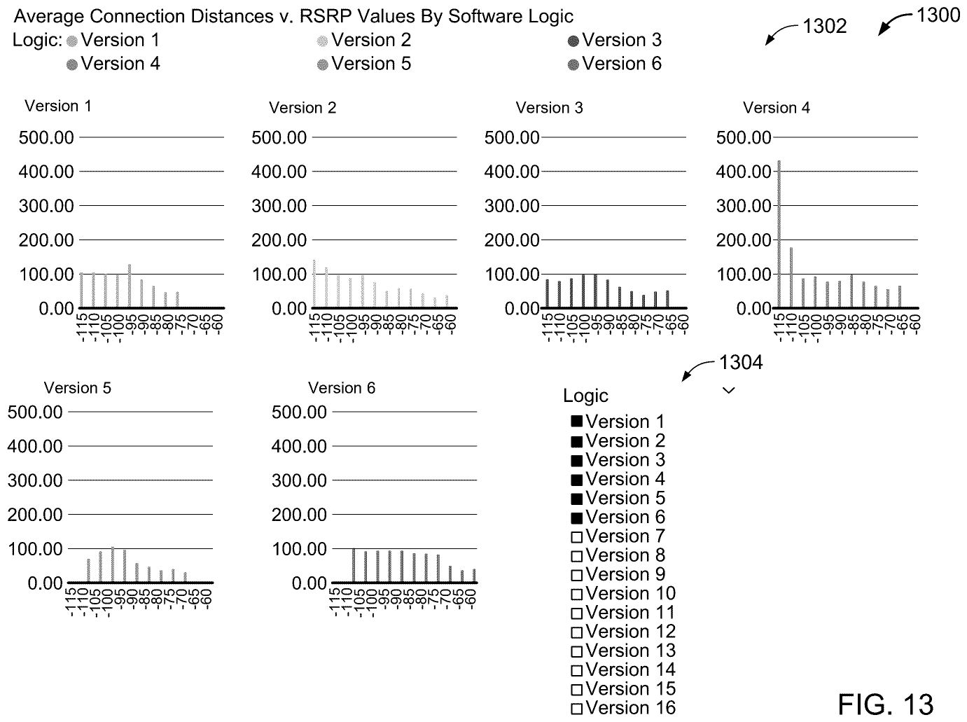

FIG. 13 shows a user interface 1300 that displays information about the connection distances of the user device connections during data collection (e.g., operations 102 and 104 of the process 100). Visualization 1302 of the user interface 1300 shows, for each of six different software logics, connection distances (shown on the y-axis, in meters) for various RSRP values (shown on the x-axis, in dBm). The user interface 1300 further includes a menu 1304 that includes multiple user-selectable options corresponding to different software logics. These user-selectable options enable a user to rapidly and dynamically update the visualizations to analyze similar performance characteristics for different software logics of interest.

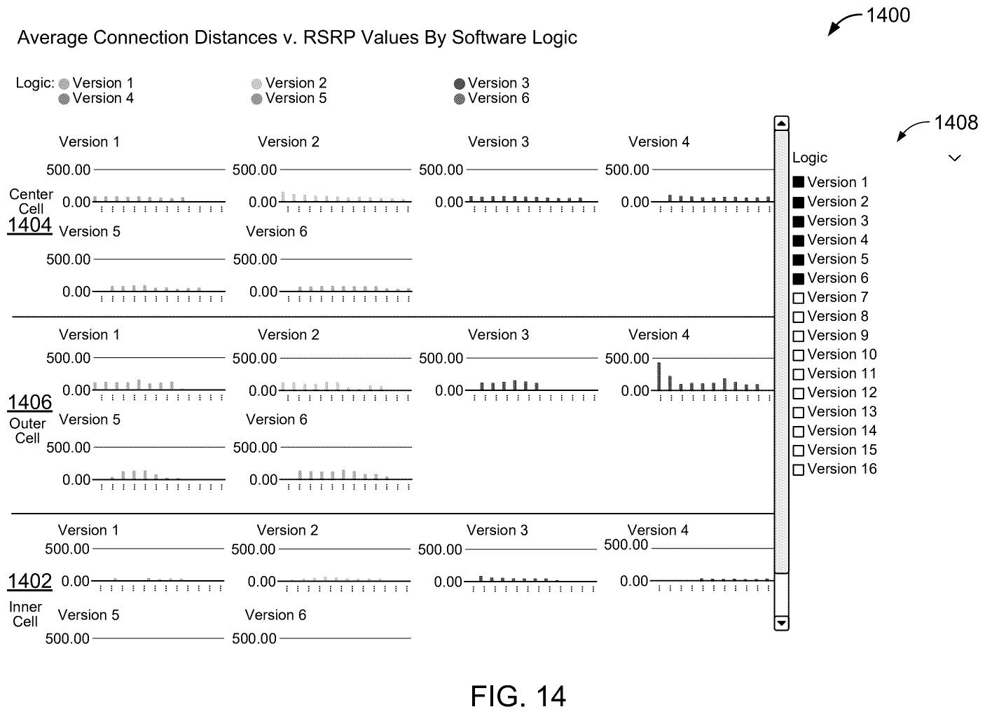

FIG. 14 shows a user interface 1400 that displays the same data as the user interface 1300 in FIG. 13, but in a disaggregated format such that separate plots have been generated based on whether the user device is located in an inner portion of a network cell (“inner cell” visualizations 1402), a middle portion of the network cell (“center cell” plots 1404), or an outer portion of the network cell (“outer cell” 1406). The user interface 1400 further includes a menu 1408 that includes multiple user-selectable options corresponding to different software logics. These user-selectable options enable a user to rapidly and dynamically update the visualizations to analyze similar performance characteristics for different software logics of interest.

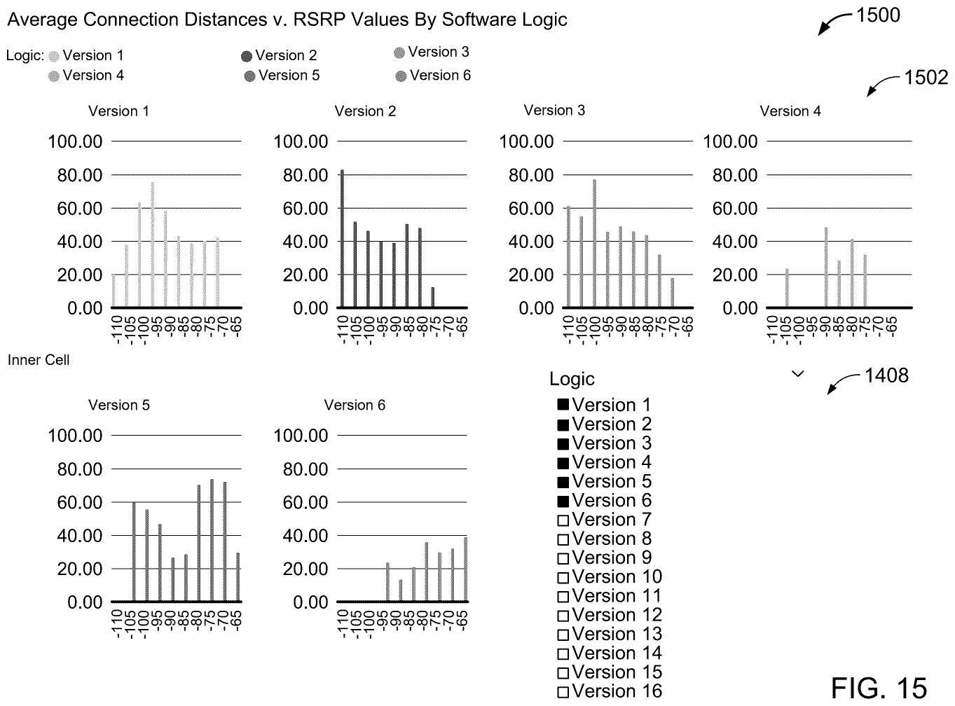

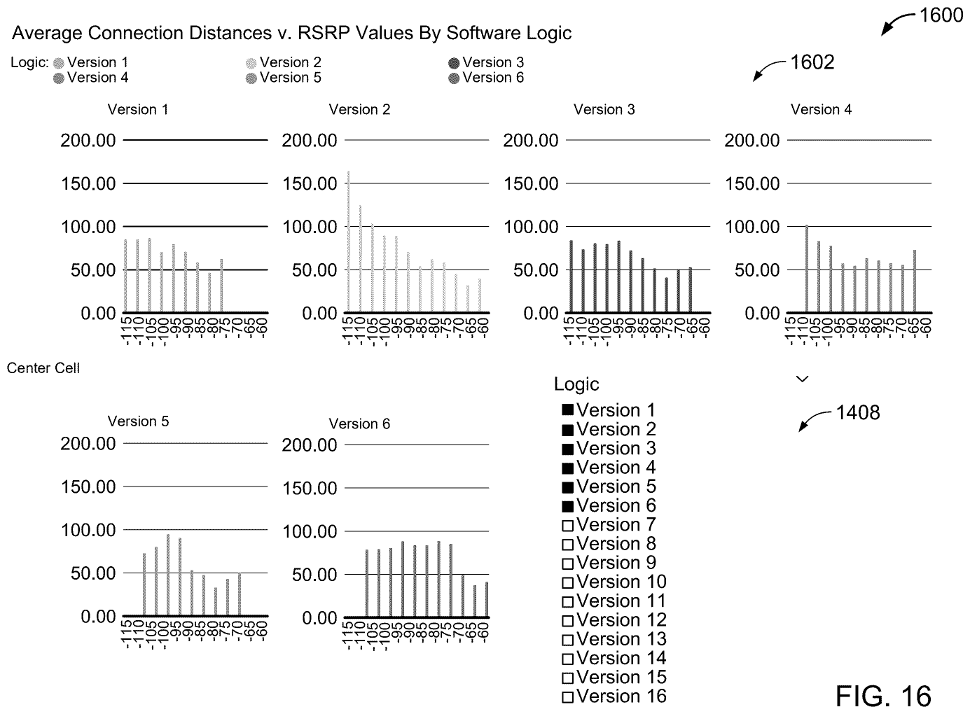

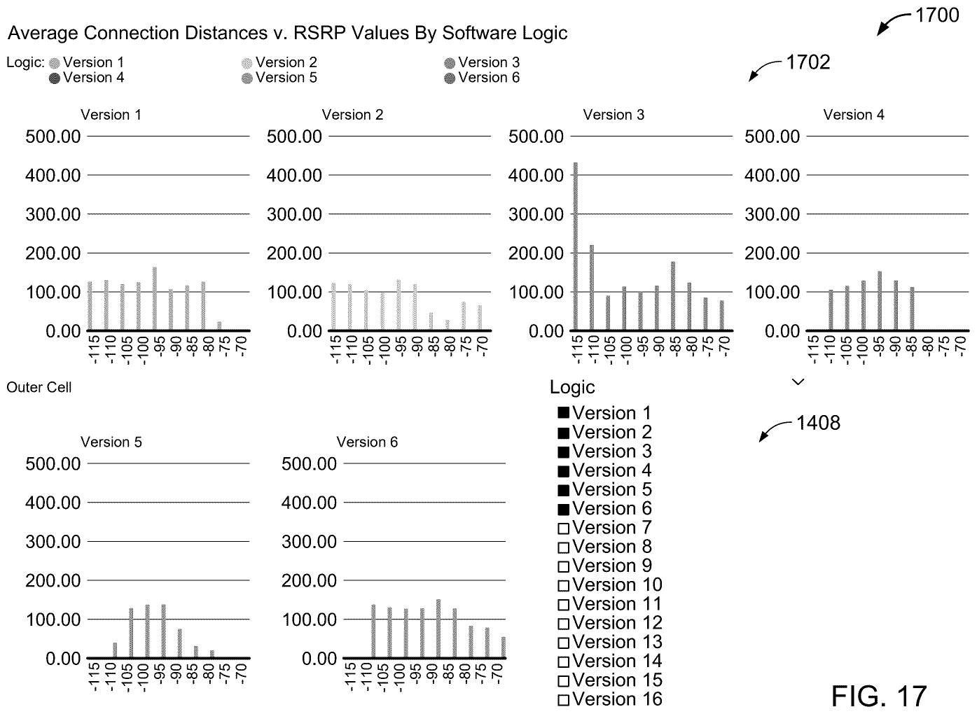

Since the scale of the y-axes in the visualizations shown in the user interface 1400 make distinctions between the logics difficult to assess, a user may wish to view only a portion of the visualizations 1402, 1404, 1406 and alter the y-axis scale for these visualizations. This is enabled by the technology disclosed herein and is shown in FIGS. 15-17. FIG. 15 shows a user interface 1500 with re-scaled visualizations 1502 corresponding to the “inner cell” visualizations 1402 of the user interface 1400. FIG. 16 shows a user interface 1600 with re-scaled visualizations 1602 corresponding to the “center cell” plots 1404 of the user interface 1400. FIG. 17 shows a user interface 1700 with re-scaled visualizations 1702 corresponding to the “center cell” plots 1404 of the user interface 1400. As shown from FIGS. 15-17, the connection distances associated with the “inner cell” sub-group were generally the shortest and the connection distances associated with the “outer cell” sub-group were generally the longest, although variation existed between different software logics. All three user interfaces (1500, 1600, 1700) include the same menu 1408 that includes multiple user-selectable options corresponding to different software logics. These user-selectable options enable a user to rapidly and dynamically update the visualizations to analyze similar performance characteristics for different software logics of interest.

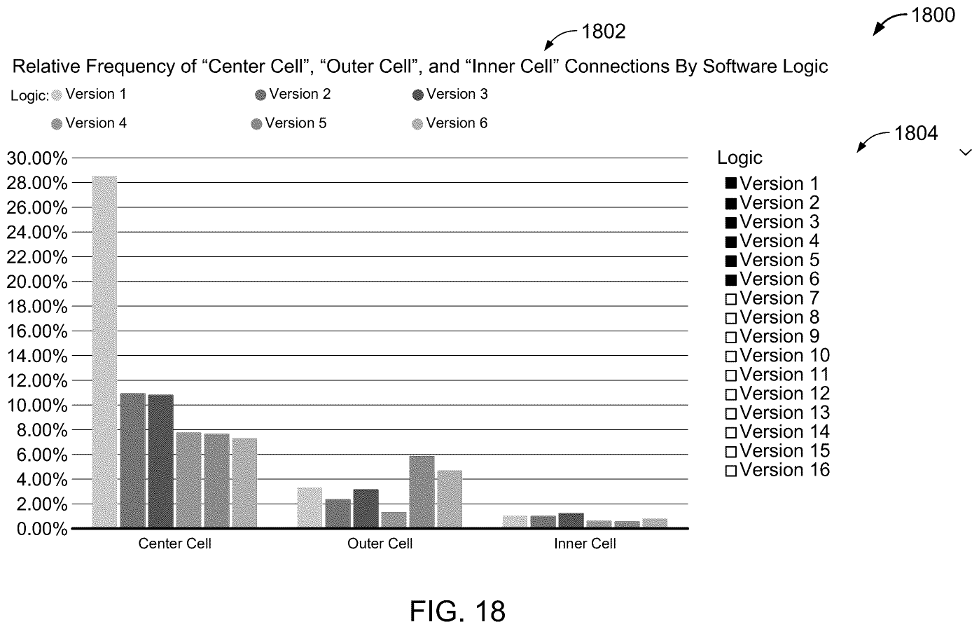

FIG. 18 shows a user interface 1800 that shows a grouped bar plot visualization 1802 with data grouped into the same “inner cell,” “center cell,” and “outer cell” categories described in relation to FIGS. 14-17. As mentioned above, these categories can serve as proxies for connection distances, and the visualization 1802 allows for direct comparison of the relative proportion of “inner cell,” “center cell,” and “outer cell” connections for six different software logics. The user interface 1800 further includes a menu 1804 that includes multiple user-selectable options corresponding to different software logics. These user-selectable options enable a user to rapidly and dynamically update the visualizations to analyze similar performance characteristics for different software logics of interest.

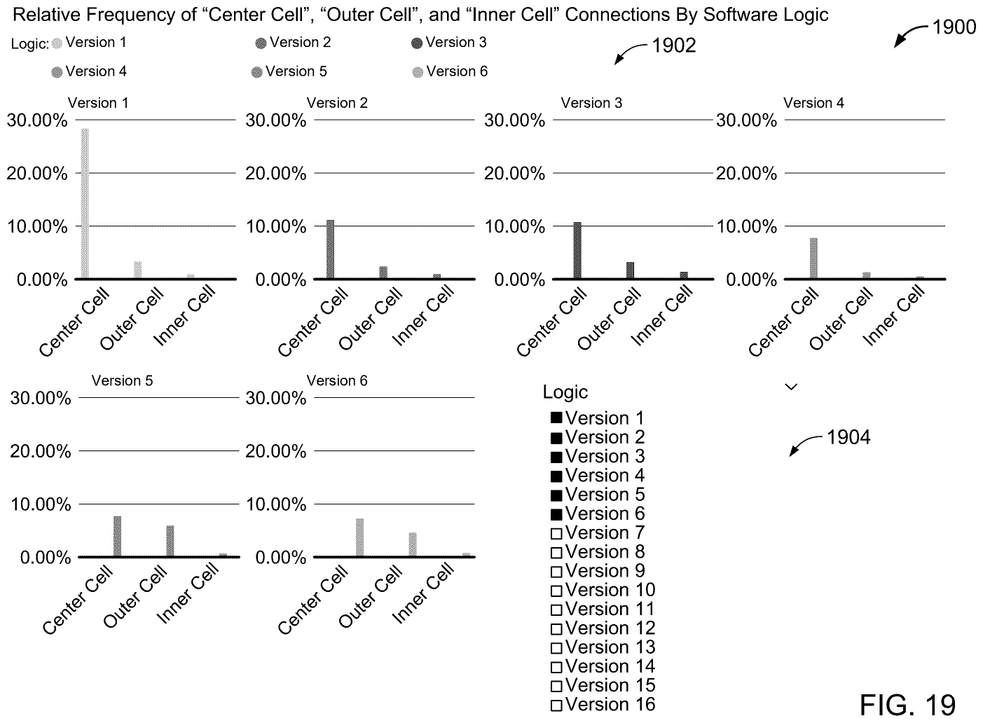

FIG. 19 shows a user interface 1900 that displays the same data as the user interface 1800 in FIG. 18, but in a slightly different format. In the visualization 1902 of the user interface 1900, the data from the grouped bar plot visualization 1802 of FIG. 18 has been split into six separate plots, each corresponding to a single software logic.

Compared to the visualization 1802, a user may find the visualization 1902 easier to interpret for making comparisons between different software logics. The user interface 1900 further includes a menu 1904 that includes multiple user-selectable options corresponding to different software logics. These user-selectable options enable a user to rapidly and dynamically update the visualizations to analyze similar performance characteristics for different software logics of interest.

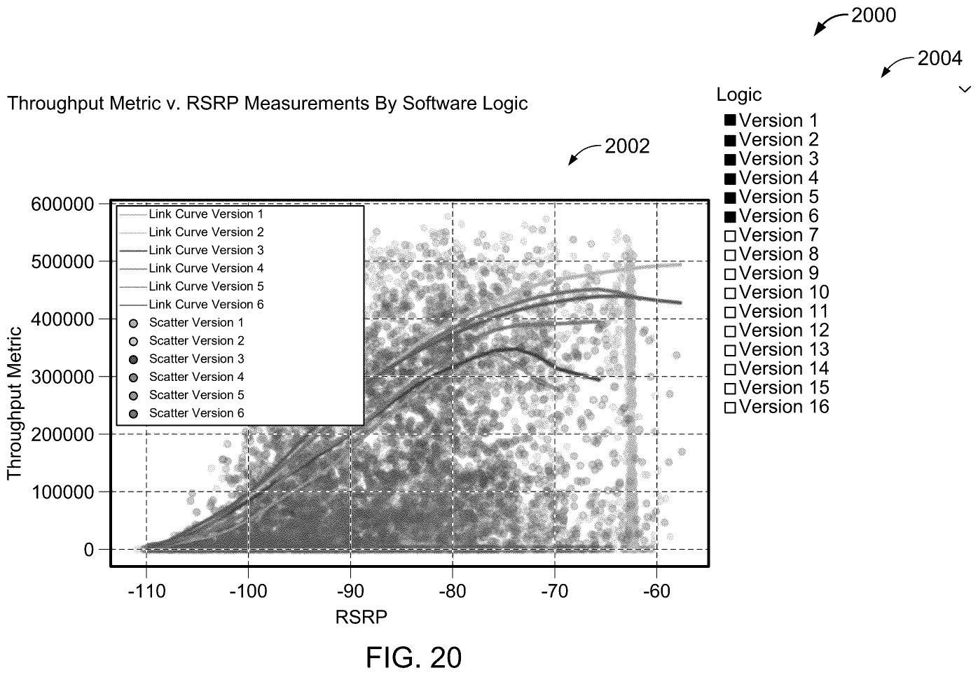

FIG. 20 shows a user interface 2000 that displays information about the signal strength and throughput of the user device connections during data collection (e.g., operations 102 and 104 of the process 100). Visualization 2002 of the user interface 2000 shows, for six different software logics, a scatterplot of RSRP and a throughput metric.

For ease of comparison between logics, the visualization 2002 further includes “link curves” for each of the software logics. These link curves represent a summary statistic calculated by aggregating the throughput values for individual points in the scatterplot.

For example, the throughput values for the link curves can be calculated using an exponentially weighted average of the throughput values for individual points in the scatterplot, and in some implementations, the link curves can be further smoothed (e.g., using a Gaussian filter). The user interface 2000 further includes a menu 2004 that includes multiple user-selectable options corresponding to different software logics. These user-selectable options enable a user to rapidly and dynamically update the visualizations to analyze similar performance characteristics for different software logics of interest.

FIG. 21 shows an example of a computing device 2100 and a mobile computing device 2150 that are employed to execute implementations of the present disclosure. For example, the computing device 2100 and/or the mobile computing device 2150 can correspond to the devices of the cellular network (e.g., small cells or other wireless equipment) employed to execute the process 100. The computing device 2100 and/or the mobile computing device 2150 can also correspond to the user devices (UEs) described above and/or any device on which visualizations such as those shown in FIGS. 4-20 are presented.

The mobile computing device 2150 is intended to represent various forms of mobile devices, such as personal digital assistants, cellular telephones, smart-phones, AR devices, and other similar computing devices. The components shown here, their connections and relationships, and their functions, are meant to be examples only, and are not meant to be limiting.

The computing device 2100 includes a processor 2102, a memory 2104, a storage device 2106, a high-speed interface 2108, and a low-speed interface 2112. In some implementations, the high-speed interface 2108 connects to the memory 2104 and multiple high-speed expansion ports 2110. In some implementations, the low-speed interface 2112 connects to a low-speed expansion port 2114 and the storage device 2104. Each of the processor 2102, the memory 2104, the storage device 2106, the high-speed interface 2108, the high-speed expansion ports 2110, and the low-speed interface 2112, are interconnected using various buses, and may be mounted on a common motherboard or in other manners as appropriate. The processor 2102 can process instructions for execution within the computing device 2100, including instructions stored in the memory 2104 and/or on the storage device 2106 to display graphical information for a graphical user interface (GUI) on an external input/output device, such as a display 2116 coupled to the high-speed interface 2108. In other implementations, multiple processors and/or multiple buses may be used, as appropriate, along with multiple memories and types of memory. In addition, multiple computing devices may be connected, with each device providing portions of the necessary operations (e.g., as a server bank, a group of blade servers, or a multi-processor system).

The memory 2104 stores information within the computing device 2100. In some implementations, the memory 2104 is a volatile memory unit or units. In some implementations, the memory 2104 is a non-volatile memory unit or units. The memory 2104 may also be another form of a computer-readable medium, such as a magnetic or optical disk.

The storage device 2106 is capable of providing mass storage for the computing device 2100. In some implementations, the storage device 2106 may be or include a computer-readable medium, such as a floppy disk device, a hard disk device, an optical disk device, a tape device, a flash memory, or other similar solid-state memory device, or an array of devices, including devices in a storage area network or other configurations. Instructions can be stored in an information carrier. The instructions, when executed by one or more processing devices, such as processor 2102, perform one or more methods, such as those described above. The instructions can also be stored by one or more storage devices, such as computer-readable or machine-readable mediums, such as the memory 2104, the storage device 2106, or memory on the processor 2102.

The high-speed interface 2108 manages bandwidth-intensive operations for the computing device 2100, while the low-speed interface 2112 manages lower bandwidth-intensive operations. Such allocation of functions is an example only. In some implementations, the high-speed interface 2108 is coupled to the memory 2104, the display 2116 (e.g., through a graphics processor or accelerator), and to the high-speed expansion ports 2110, which may accept various expansion cards. In the implementation, the low-speed interface 2112 is coupled to the storage device 2106 and the low-speed expansion port 2114. The low-speed expansion port 2114, which may include various communication ports (e.g., Universal Serial Bus (USB), Bluetooth, Ethernet, wireless Ethernet) may be coupled to one or more input/output devices. Such input/output devices may include a scanner, a printing device, or a keyboard or mouse. The input/output devices may also be coupled to the low-speed expansion port 2114 through a network adapter. Such network input/output devices may include, for example, a switch or router.

The computing device 2100 may be implemented in a number of different forms, as shown in FIG. 21. For example, it may be implemented as a standard server 2120, or multiple times in a group of such servers. In addition, it may be implemented in a personal computer such as a laptop computer 2122. It may also be implemented as part of a rack server system 2124. Alternatively, components from the computing device 2100 may be combined with other components in a mobile device, such as a mobile computing device 2150. Each of such devices may contain one or more of the computing device 2100 and the mobile computing device 2150, and an entire system may be made up of multiple computing devices communicating with each other.

The mobile computing device 2150 includes a processor 2152; a memory 2164; an input/output device, such as a display 2154; a communication interface 2166; and a transceiver 2168; among other components. The mobile computing device 2150 may also be provided with a storage device, such as a micro-drive or other device, to provide additional storage. Each of the processor 2152, the memory 2164, the display 2154, the communication interface 2166, and the transceiver 2168, are interconnected using various buses, and several of the components may be mounted on a common motherboard or in other manners as appropriate. In some implementations, the mobile computing device 2150 may include a camera device(s).

The processor 2152 can execute instructions within the mobile computing device 2150, including instructions stored in the memory 2164. The processor 2152 may be implemented as a chipset of chips that include separate and multiple analog and digital processors. For example, the processor 2152 may be a Complex Instruction Set Computers (CISC) processor, a Reduced Instruction Set Computer (RISC) processor, or a Minimal Instruction Set Computer (MISC) processor. The processor 2152 may provide, for example, for coordination of the other components of the mobile computing device 2150, such as control of user interfaces (UIs), applications run by the mobile computing device 2150, and/or wireless communication by the mobile computing device 2150.

The processor 2152 may communicate with a user through a control interface 2158 and a display interface 2156 coupled to the display 2154. The display 2154 may be, for example, a Thin-Film-Transistor Liquid Crystal Display (TFT) display, an Organic Light Emitting Diode (OLED) display, or other appropriate display technology. The display interface 2156 may include appropriate circuitry for driving the display 2154 to present graphical and other information to a user. The control interface 2158 may receive commands from a user and convert them for submission to the processor 2152. In addition, an external interface 2162 may provide communication with the processor 2152, so as to enable near area communication of the mobile computing device 2150 with other devices. The external interface 2162 may provide, for example, for wired communication in some implementations, or for wireless communication in other implementations, and multiple interfaces may also be used.

The memory 2164 stores information within the mobile computing device 2150. The memory 2164 can be implemented as one or more of a computer-readable medium or media, a volatile memory unit or units, or a non-volatile memory unit or units. An expansion memory 2174 may also be provided and connected to the mobile computing device 2150 through an expansion interface 2172, which may include, for example, a Single in Line Memory Module (SIMM) card interface. The expansion memory 2174 may provide extra storage space for the mobile computing device 2150, or may also store applications or other information for the mobile computing device 2150. Specifically, the expansion memory 2174 may include instructions to carry out or supplement the processes described above, and may include secure information also. Thus, for example, the expansion memory 2174 may be provided as a security module for the mobile computing device 2150, and may be programmed with instructions that permit secure use of the mobile computing device 2150. In addition, secure applications may be provided via the SIMM cards, along with additional information, such as placing identifying information on the SIMM card in a non-hackable manner.

The memory may include, for example, flash memory and/or non-volatile random access memory (NVRAM), as discussed below. In some implementations, instructions are stored in an information carrier. The instructions, when executed by one or more processing devices, such as processor 2152, perform one or more methods, such as those described above. The instructions can also be stored by one or more storage devices, such as one or more computer-readable or machine-readable mediums, such as the memory 2164, the expansion memory 2174, or memory on the processor 2152. In some implementations, the instructions can be received in a propagated signal, such as, over the transceiver 2168 or the external interface 2162.

The mobile computing device 2150 may communicate wirelessly through the communication interface 2166, which may include digital signal processing circuitry where necessary. The communication interface 2166 may provide for communications under various modes or protocols, such as Global System for Mobile communications (GSM) voice calls, Short Message Service (SMS), Enhanced Messaging Service (EMS), Multimedia Messaging Service (MMS) messaging, code division multiple access (CDMA), time division multiple access (TDMA), Personal Digital Cellular (PDC), Wideband Code Division Multiple Access (WCDMA), CDMA2000, General Packet Radio Service (GPRS). Such communication may occur, for example, through the transceiver 2168 using a radio frequency. In addition, short-range communication, such as using a Bluetooth or Wi-Fi, may occur. In addition, a Global Positioning System (GPS) receiver module 2170 may provide additional navigation-and location-related wireless data to the mobile computing device 2150, which may be used as appropriate by applications running on the mobile computing device 2150.

The mobile computing device 2150 may also communicate audibly using an audio codec 2160, which may receive spoken information from a user and convert it to usable digital information. The audio codec 2160 may likewise generate audible sound for a user, such as through a speaker, e.g., in a handset of the mobile computing device 2150. Such sound may include sound from voice telephone calls, may include recorded sound (e.g., voice messages, music files, etc.) and may also include sound generated by applications operating on the mobile computing device 2150.

The mobile computing device 2150 may be implemented in a number of different forms, as shown in FIG. 21. For example, it may be implemented a phone device 2180, a personal digital assistant 2182, and a tablet device (not shown). The mobile computing device 2150 may also be implemented as a component of a smart-phone, AR device, or other similar mobile device.

Computing device 2100 and/or 2150 can also include USB flash drives. The USB flash drives may store operating systems and other applications. The USB flash drives can include input/output components, such as a wireless transmitter or USB connector that may be inserted into a USB port of another computing device.

Other embodiments and applications not specifically described herein are also within the scope of the following claims. Elements of different implementations described herein may be combined to form other embodiments not specifically set forth above. Elements may be left out of the structures described herein without adversely affecting their operation. Furthermore, various separate elements may be combined into one or more individual elements to perform the functions described herein.

What is claimed is:

1. A method comprising:
receiving, from one or more first user devices, first data indicative of a performance of a first version of a software package installed on wireless equipment of a cellular network, the first data being collected as the one or more first user devices attempt to connect to the cellular network while traversing a first route within a geographic region containing the wireless equipment;
receiving, from one or more second user devices, second data indicative of a performance of a second version of the software package installed on the wireless equipment of the cellular network, the second data being collected as the one or more second user devices attempt to connect to the cellular network while traversing a second route within the geographic region; and
presenting, on a display of a computing device, a user interface comprising one or more data visualizations of the first data and the second data,
wherein the user interface further comprises one or more user-selectable options, each user-selectable option corresponding to a particular version of the software package, and
wherein the one or more data visualizations are configured to dynamically update based on a user selection of the one or more user-selectable options.

2. The method of claim 1, wherein at least some of the one or more first user devices are the same devices as at least some of the one or more second user devices.

3. The method of claim 1, wherein the first route within the geographic region is substantially similar to the second route within the geographic region.

4. The method of claim 1, wherein the first version of the software package and the second version of the software package control parameters of the wireless equipment of the cellular network; manage interference on the cellular network; broadcast, establish, and release connections to the cellular network; handle data transmissions within the cellular network; and/or initiate and manage calls.

5. The method of claim 1, wherein the first data and the second data each comprise information representative of a signal strength of a connection to the cellular network, a throughput of the cellular network, a coverage distance of the cellular network, and/or a technology mode of the wireless equipment of the cellular network.

6. The method of claim 1, further comprising comparing the performance of the first version of the software package with the performance of the second version of the software package based on the one or more data visualizations.

7. The method of claim 1, further comprising determining, based on the one or more data visualizations, whether a performance characteristic of the first version of the software package and/or the second version of the software package satisfy a pre-defined threshold level corresponding to the performance characteristic.

8. The method of claim 7, wherein the pre-defined threshold level corresponds to a level of the performance characteristic achieved by a pre-existing version of the software package.

9. The method of claim 1, further comprising:
comparing the first data and the second data;
in response to comparing the first data and the second data, selecting whether to implement the first version of the software package or the second version of the software package in additional wireless equipment of the cellular network outside of the geographic region; and
implementing, in accordance with the selection, the first version of the software package or the second version of the software package in the additional wireless equipment of the cellular network outside of the geographic region.

10. The method of claim 1, further comprising:
comparing the first data and the second data;
in response to comparing the first data and the second data, automatically identifying a performance characteristic of the first version of the software package and/or the second version of the software package that does not satisfy a pre-defined threshold level corresponding to the performance characteristic; and
presenting, on the display of the computing device, a recommendation to modify a feature of the first version of the software package and/or a feature of the second version of the software package relating to the identified performance characteristic.

11. A computing system comprising:
a display;
a memory configured to store instructions; and
one or more processors configured to execute the instructions to perform operations comprising:
receiving, from one or more first user devices, first data indicative of a performance of a first version of a software package installed on wireless equipment of a cellular network, the first data being collected as the one or more first user devices attempt to connect to the cellular network while traversing a first route within a geographic region containing the wireless equipment;
receiving, from one or more second user devices, second data indicative of a performance of a second version of the software package installed on the wireless equipment of the cellular network, the second data being collected as the one or more second user devices attempt to connect to the cellular network while traversing a second route within the geographic region; and
presenting, on the display of the computing system, a user interface comprising one or more data visualizations of the first data and the second data,
wherein the user interface further comprises one or more user-selectable options, each user-selectable option corresponding to a particular version of the software package, and
wherein the one or more data visualizations are configured to dynamically update based on a user selection of the one or more user-selectable options.

12. The computing system of claim 11, wherein at least some of the one or more first user devices are the same devices as at least some of the one or more second user devices.

13. The computing system of claim 11, wherein the first route within the geographic region is substantially similar to the second route within the geographic region.

14. The computing system of claim 11, wherein the first version of the software package and the second version of the software package control parameters of the wireless equipment of the cellular network; manage interference on the cellular network;
broadcast, establish, and release connections to the cellular network; handle data transmissions within the cellular network; and/or initiate and manage calls.

15. The computing system of claim 11, wherein the first data and the second data each comprise information representative of a signal strength of a connection to the cellular network, a throughput of the cellular network, a coverage distance of the cellular network, and/or a technology mode of the wireless equipment of the cellular network.

16. The computing system of claim 11, wherein the operations comprise comparing the performance of the first version of the software package with the performance of the second version of the software package based on the one or more data visualizations.

17. The computing system of claim 11, wherein the operations comprise determining, based on the one or more data visualizations, whether a performance characteristic of the first version of the software package and/or the second version of the software package satisfy a pre-defined threshold level corresponding to the performance characteristic.

18. The computing system of claim 17, wherein the pre-defined threshold level corresponds to a level of the performance characteristic achieved by a pre-existing version of the software package.

19. The computing system of claim 1, wherein the operations comprise:
comparing the first data and the second data;
in response to comparing the first data and the second data, selecting whether to implement the first version of the software package or the second version of the software package in additional wireless equipment of the cellular network outside of the geographic region; and
implementing, in accordance with the selection, the first version of the software package or the second version of the software package in the additional wireless equipment of the cellular network outside of the geographic region.

20. The computing system of claim 1, wherein the operations comprise:
comparing the first data and the second data;
in response to comparing the first data and the second data, automatically identifying a performance characteristic of the first version of the software package and/or the second version of the software package that does not satisfy a pre-defined threshold level corresponding to the performance characteristic; and
presenting, on the display of the computing system, a recommendation to modify a feature of the first version of the software package and/or a feature of the second version of the software package relating to the identified performance characteristic.

21. One or more non-transitory machine-readable readable storage media storing instructions that are executed to perform operations comprising:
receiving, from one or more first user devices, first data indicative of a performance of a first version of a software package installed on wireless equipment of a cellular network, the first data being collected as the one or more first user devices attempt to connect to the cellular network while traversing a first route within a geographic region containing the wireless equipment;
receiving, from one or more second user devices, second data indicative of a performance of a second version of the software package installed on the wireless equipment of the cellular network, the second data being collected as the one or more second user devices attempt to connect to the cellular network while traversing a second route within the geographic region; and
presenting, on a display of a computing device, a user interface comprising one or more data visualizations of the first data and the second data,
wherein the user interface further comprises one or more user-selectable options, each user-selectable option corresponding to a particular version of the software package, and
wherein the one or more data visualizations are configured to dynamically update based on a user selection of the one or more user-selectable options.
